(19) United States
(12) Patent Application Publication
(10) Pub. No.: US 2018/0091301 A1
(43) Pub. Date: Mar. 29, 2018

(54) METHOD AND SYSTEM FOR SWITCHING PUBLIC KEYS IN CIPHERTEXTS

(71) Applicant: ZeroDB, Inc., Santa Clara, CA (US)

(72) Inventors: David Nuñez, Santa Clara, CA (US); Isaac Agudo, Santa Clara, CA (US); Mikhail Egorov, Santa Clara, CA (US); MacLane Scott Wilkison, Santa Clara, CA (US)

(21) Appl. No.: 15/825,821

(22) Filed: Nov. 29, 2017

Related U.S. Application Data
(63) Continuation-in-part of application No. 15/588,614, filed on May 6, 2017.
(60) Provisional application No. 62/427,401, filed on Nov. 29, 2016.
(60) Provisional application No. 62/332,840, filed on May 6, 2016.

(51) Int. Cl. H04L 9/30; G06F 9/30; H04L 9/06; G06F 21/62; H04L 9/08

(52) U.S. Cl. CPC H04L 9/3073; G06F 9/30029; H04L 9/0844; G06F 21/62; H04L 9/06

(57) ABSTRACT

Provided is a process, including: obtaining a first ciphertext; obtaining the field size with which the first ciphertext was encrypted; obtaining a first private encryption key of the first encryption key pair; receiving a request to delegate access to the first ciphertext to a second recipient; obtaining a second private encryption key; determining a key-switching key based on the field size, the first private encryption key, and the second private encryption key; in response to the request, delegating access by forming a second ciphertext from which the plaintext is accessible with the second private encryption key; and storing the second ciphertext in memory.

### CROSS-REFERENCE TO RELATED APPLICATIONS

The present application is a non-provisional of, and thus claims the benefit of, U.S. Provisional Patent Application 62/427,401, titled METHOD AND SYSTEM FOR SWITCHING PUBLIC KEYS IN CIPHERTEXTS, filed 29 Nov. 2016, and is a continuation-in-part of U.S. patent application Ser. No. 15/588,614, titled ENCRYPTION FOR DISTRIBUTED STORAGE AND PROCESSING, filed 06 May 2017, which claims the benefit of U.S. Provisional Patent Application 62/332,840, titled ENCRYPTION FOR DISTRIBUTED STORAGE AND PROCESSING, filed 06 May 2016. The entire content of each afore-mentioned patent filing is hereby incorporated by reference.

### BACKGROUND

### 1. Field

The present disclosure relates to cryptographic mechanisms for secure (e.g., secret) communication, and in particular to the use of intermediary entities to perform cryptographic operations.

### 2. Description of the Related Art

Conventional public-key encryption schemes allow an entity holding a private key related to some public key to decrypt ciphertexts encrypted under said public key. The encryption scheme proposed by ElGamal is one example of public-key encryption scheme (see ElGamal, T. (1984, August). A public key cryptosystem and a signature scheme based on discrete logarithms. In Workshop on the Theory and Application of Cryptographic Techniques (pp. 10-18). Springer Berlin Heidelberg.) Public-key encryption is one of the basic tools of public-key infrastructures. Among other uses, public key encryption provides an algorithm by which one party (e.g., Alice) can communicate with another (e.g., Bob) over an untrusted channel without a shared secret key being known to both sender and receiver. For example, Alice, upon determining to send a plaintext message to Bob, might obtain Bob's public key. This public key algorithmically corresponds to a private (and secret) key held by Bob, but unknown to Alice and others. The nature of this correspondence is such that, once Alice encrypts the message into a cyphertext with Bob's public key, only the party with the corresponding private key (i.e., Bob) can decrypt the message. Similar use cases exist for cryptographic signatures, where a party's public key is used to verify that an entity with access to the corresponding private key signed a document. In some cases, public-key encryption is used to exchange a symmetric encryption key (e.g., a shared secret, high entropy value) that is then used to encrypt and decrypt subsequent messages more efficiently than with public-key encryption.

In recent years, research on more advanced functionalities has been conducted in relation with public-key encryption, leading to schemes where decryption of ciphertexts originally encrypted by some public key can be performed with a private key not associated with said public key. This is what is knows as “Proxy re-encryption” by the scientific community. There are several proxy re-encryption schemes in the literature, being the most prominent those based on ElGamal public-key encryption scheme, such as the ones proposed by Blaze et al. (see Blaze, M., Bleumer, G., & Strauss, M. (1998, May). Divertible protocols and atomic proxy cryptography. In International Conference on the Theory and Applications of Cryptographic Techniques (pp. 127-144). Springer Berlin Heidelberg) and Ateniese et al. (see Ateniese, G., Fu, K., Green, M., & Hohenberger, S. (2006). Improved proxy re-encryption schemes with applications to secure distributed storage. ACM Transactions on Information and System Security (TISSEC), 9(1), 1-30.)). However, none of the proxy re-encryption schemes to date is compatible with any encryption standard due to a variety of technical problems that remain to be solved to achieve compatibility.

One standard expected to see even broader use in the future is the Elliptic Curve Integrated Encryption Scheme (ECIES) standard, which is a hybrid encryption algorithm based on elliptic curves, defined by the ANSI X9.63 standard (see American National Standard for Financial Services. (2011). X9.63-2011. Public Key Cryptography for the Financial Services Industry: Key Agreement and Key Transport using Elliptic Curve Cryptography), where it is simply called Asymmetric Encryption Scheme. This algorithm is of public knowledge, and variants have been standardized also by ISO/IEC and IEEE. When producing a ciphertext with ECIES, the sender first creates an ephemeral public key and uses it in a Diffie-Hellman key agreement together with the public key of the intended recipient. The resulting shared secret is used to create the keys for the symmetric encryption and message authentication code algorithms used internally. The final ciphertext contains the ephemeral public key, which is used for decryption, and the outputs of the symmetric encryption and message authentication code algorithms.

### SUMMARY

The following is a non-exhaustive listing of some aspects of the present techniques. These and other aspects are described in the following disclosure.

Some aspects include cryptographic process for secret or secure communication, and in particular to the use of intermediary entities to perform cryptographic operations, the process including: obtaining, with one or more processors, a first ciphertext, wherein: the first ciphertext is formed by encrypting a plaintext message with elliptic curve encryption; the elliptic curve encryption has a field size as a domain parameter; the field size is a prime number; the first ciphertext is encrypted based on a first public encryption key of a first recipient; the first public encryption key is part of a first encryption key pair; the first encryption key pair includes a first private encryption key corresponding to the first public encryption key; and the first ciphertext requires access to the first private encryption key to access the plaintext from the first ciphertext; obtaining, with one or more processors, the field size with which the first ciphertext was encrypted; obtaining, with one or more processors, the first private encryption key of the first encryption key pair; receiving, with one or more processors, a request to delegate access to the first ciphertext to a second recipient different from the first recipient, wherein: the second recipient corresponds to a second encryption key pair different from the first encryption key pair; and the second encryption key pair includes a second public encryption key and a second private encryption key; obtaining, with one or more processors, the second private encryption key; determining, with one or more processors, a key-switching key based on the field size, the first private encryption key, and the second private encryption key; in response to the request, delegating access by forming a second ciphertext from which the plaintext is accessible with the second private encryption key, wherein: forming the second ciphertext is performed without decrypting the first ciphertext or accessing the plaintext; forming the second ciphertext is performed without the second private encryption key; the second ciphertext requires access to the second private encryption key to access the plaintext from the second ciphertext; and the second ciphertext is formed based on the first ciphertext and the key-switching key; and storing, with one or more processors, the second ciphertext in memory.

Some aspects include a tangible, non-transitory, machine-readable medium storing instructions that when executed by a data processing apparatus cause the data processing apparatus to perform operations including the above-mentioned process.

Some aspects include a system, including: one or more processors; and memory storing instructions that when executed by the processors cause the processors to effectuate operations of the above-mentioned process.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 is a flowchart depicting an example of data flows of ECIES ciphertexts with respect to encryption, key switching, and decryption procedures in accordance with various embodiments;

FIG. 2 is a flowchart of an example of a process for switching public keys on ECIES ciphertexts in accordance with various embodiments;

FIG. 3 is a flowchart of an example of a process for generating key-switching keys in accordance with various embodiments;

FIG. 4 is a block diagram depicting an example of a use case with one sender and one delegated recipient in accordance with various embodiments;

FIG. 5 is a block diagram depicting an example of a use case with one sender and multiple delegated recipients in accordance with various embodiments;

FIG. 6 is a block diagram depicting an example of a use case with multiple senders and multiple delegated in accordance with various embodiments; and

FIG. 7 is a block diagram of an example of a computer system with which the above techniques may be implemented.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the field of cryptography. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

Some embodiments modify the ciphertext that is based on ephemeral public keys, like those described above, in such a way that it is possible to correctly change the intended recipient (i.e., the private key with which the ciphertext can be decrypted), without decrypting the ciphertext in the course of changing the public key for the ciphertext. That is, embodiments may receive a ciphertext encrypted based on party 1's public key (and readable by party 1's corresponding private key) and execute a transformation on the ciphertext without decrypting the ciphertext (at least in a given layer of encryption), thereby rendering the transformed ciphertext readable by party 2's private key (e.g., in a form equivalent to a ciphertext created based on party 2's public key). In other words, encrypted messages can, in effect, be re-routed without reading the message. The resulting effect is that some embodiments switch the public key of recipients in ECIES ciphertexts. It is believed that the present techniques preserve the correctness of the encryption and decryption procedure, as the resulting ciphertexts after modification are consistent with (e.g., perfectly consistent with) regular ciphertexts.

Ciphertexts amenable to such modification arise in a variety of contexts. For instance, as noted above, Asymmetric Encryption Scheme defined in standard ANSI X9.63, also known as Elliptic Curve Integrated Encryption Scheme (ECIES), is a hybrid encryption algorithm based on elliptic curves, symmetric encryption and message authentication codes. This, and each of the other standards discussed herein are hereby incorporated by reference. This algorithm is of public knowledge, and variants have been standardized also by ISO/IEC 18033-2 and IEEE P1363A. When producing a ciphertext with ECIES, the sender first creates an ephemeral public key and uses it for a Diffie-Hellman key agreement together with the public key of the intended recipient. The resulting shared secret is used to create the keys for the symmetric encryption and message authentication code algorithms used internally. In some use cases, the final ciphertext includes or is associated with the ephemeral public key, which may be used for decryption, and the output of the symmetric encryption and message authentication code algorithms.

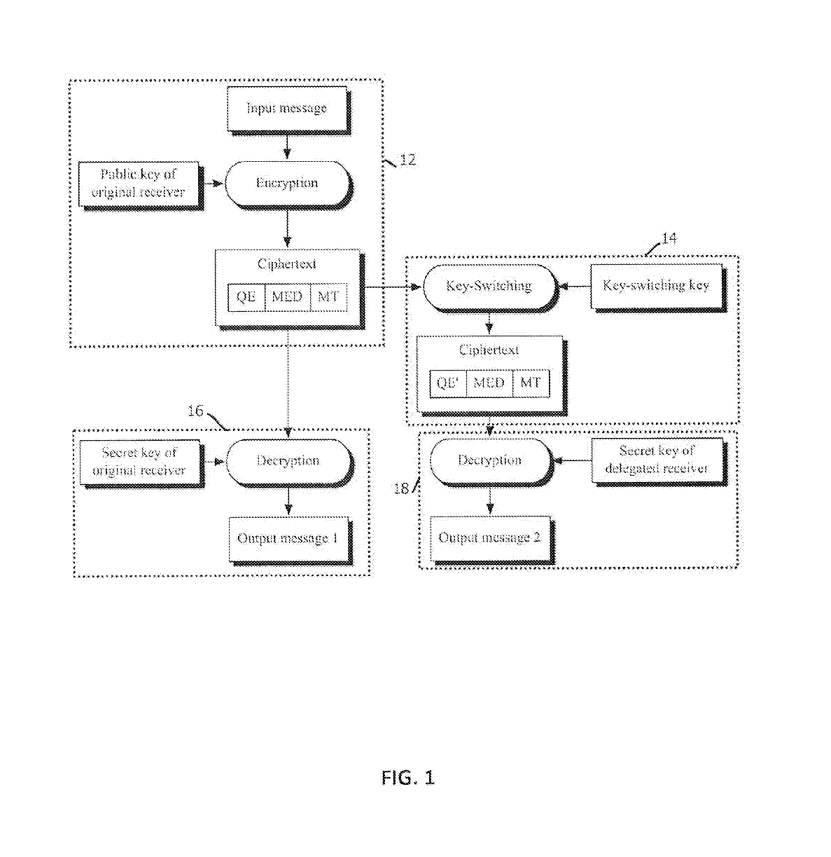

FIG. 1 is a flowchart depicting an example of data flows of ECIES ciphertexts with respect to encryption, key switching, and decryption procedures in accordance with various embodiments. The illustrated ciphertexts include (e.g., consist of or otherwise associate) three bit-strings: QE, MaskedEncData, and MacTag, denoted in the figure as QE, MED, and MT, respectively. QE is a bit-string representation of Qₑ., an ephemeral elliptic curve public key, and which corresponds to elliptic curve domain parameters q, a, b, G, n, and h defined in ANSI X9.63. QE may be appended to the result of XOR'ing an encryption key and the encrypted data to form a ciphertext. MED may be the result of XOR'ing an encryption key and the encrypted data. MT may be the MAC value described below.

Boxes 12, 14, 16, and 18 denote different computing devices or processes that communicate with one another (e.g., within a computing device, or between computing devices across a network) in the illustrated process and execute the operations shown within the respective boxes. In some cases, the computational entities of each of the boxes may not have access to the information in the other boxes beyond that shown as being communicated or described as being obtainable via decryption. An entity storing a ciphertext but without the ability to decrypt that ciphertext does not have access to the plaintext version of that ciphertext. In some cases, box 12 represents a message sending computing device; box 14 represents a key-switching server that executes the proxy re-encryption operation described below; box 16 represents an initial recipient computing device; and box 18 represents a delegated recipient computing device granted access in virtue of the proxy re-encryption operations of the re-encryption server 14.

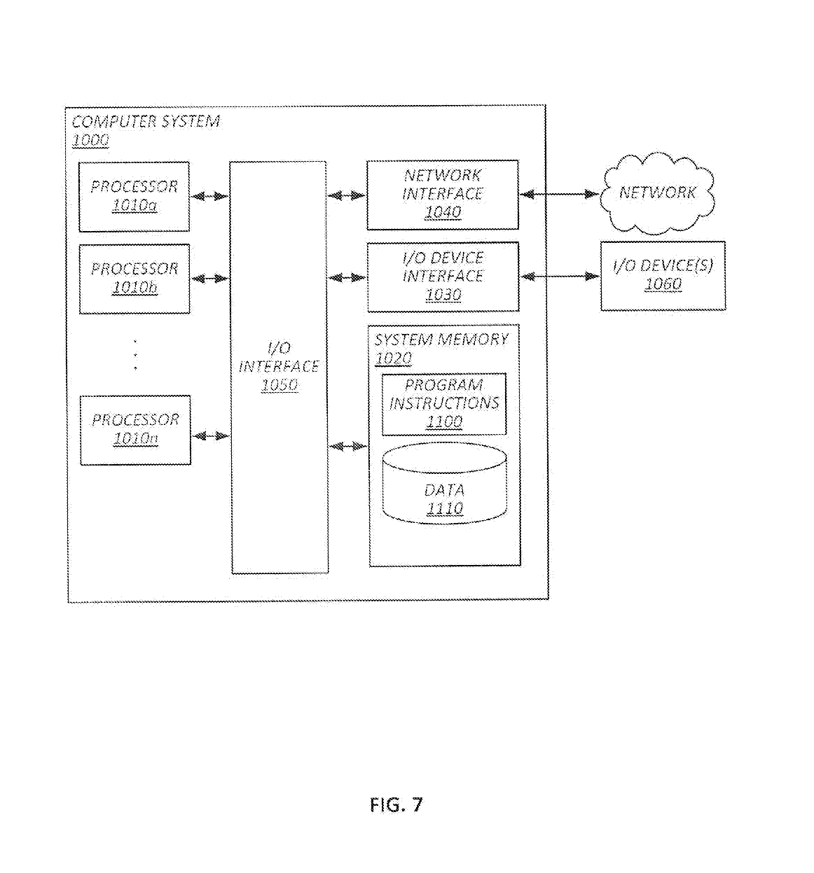

In some embodiments, the illustrated messages between the computers 12, 14, 16, and 18 are sent and received by one or more of the computer systems described below with reference to FIG. 7 over the Internet (or various other networks) from another instance of such a computer system (e.g., either another client device or a server). In some embodiments those two, three, or more computer systems may effectuate the data flow shown in FIG. 1 (and in some cases, the other figures). In some cases, instructions by which such functionality is effectuated may be stored on a tangible, non-transitory, machine readable medium, which in some cases, may be a distributed medium in which different instructions are stored on different computing devices that execute different subsets of the instructions, an arrangement consistent with the singular term “medium” as used herein. Sent “messages” may include documents or database entries that are stored for later access (e.g., reading or reading and writing) by another entity. Messages need not be “addressed” to an entity to constitute a message.

Note that the ciphertext that results from the key-switching procedure changes QE by QE′, as described in the key-switching procedure. The proof of correctness described below, in some embodiments, guarantees that the results from decryption, namely output message 1 and output message 2, are equal to the input message.

ECIES can be used in a variety of elliptic curves. Some embodiments restrict the choice of elliptic curves to those defined over a field of prime order, denoted by q.

In some embodiments, a prerequisite for operation is a set of elliptic curve (EC) domain parameters D=(q, FR, a, b, ECCSEED, G, n, h) as specified in the ANSI X9.63 standard and restricted to elliptic curves defined over a field of prime order q. This, q is a field size, and in some cases, is a prime number. In some cases, the parameters are generated using the parameter generation primitives in Section 5.1.1.1 of ANSI X9.63 (the entire contents of ANSI X9.63 are hereby incorporated by reference). Furthermore, in some cases, the parameters are validated using the parameter validation primitives in Section 5.1.1.2 of ANSI X9.63. Other embodiments may operate without these parameters, e.g., when implementing other standards, which is not to suggest that any other description is limiting.

In some embodiments, entities (e.g., the above-noted computer systems passing messages) using the scheme may establish whether to use the standard Diffie-Hellman primitive specified in Section 5.4.1 of ANSI X9.63 or the modified Diffie-Hellman primitive specified in Section 5.4.2 of ANSI X9.63. In some cases, the entities may establish whether to use the standard public key validation primitive specified in Section 5.2.2.1 of ANSI X9.63 or the embedded public key validation primitive specified in Section 5.2.2.2 of ANSI X9.63. If the standard Diffie-Hellman primitive is used, then the standard public key validation primitive may be used in some cases. In some cases, establishing which primitive to use may include one entity advertising its capabilities (e.g., which primitives are supported) in messages to a requesting entity, and the requesting entity selecting among those capabilities. Or a sending entity may select a required primitive.

In some embodiments, the entities may establish which approved MAC (message authentication code) scheme as specified in Section 5.7 of ANSI X9.63 is to be used. The MAC scheme may include an entity encrypting or re-encrypting calculating a cryptographic hash digest of a message by which changes to the message may be detected by re-calculating that value later on the message and comparing the calculated value to the previous value, with differences indicating tampering. These MAC values may indicate data integrity and authenticity. In some cases, establishing which MAC scheme to use may include one entity advertising its capabilities (e.g., which MAC schemes are supported) in messages to a requesting entity, and the requesting entity selecting among those capabilities. Or a sending entity may select a required MAC scheme.

In some embodiments, the entities may establish an approved key derivation function as specified in Section 5.6.3 of ANSI X9.63.

In operation, some embodiments may generate Key-Switching Keys. This may be based on various inputs, such as: 1) An EC private key d owned by the original recipient, which shall have been generated using the key pair generation primitive specified in the ANSI X9.63 standard, in some embodiments; and 2) An EC private key d′ owned by the delegated recipient, which may be generated using the key pair generation primitive specified in the ANSI X9.63 standard, in some embodiments.

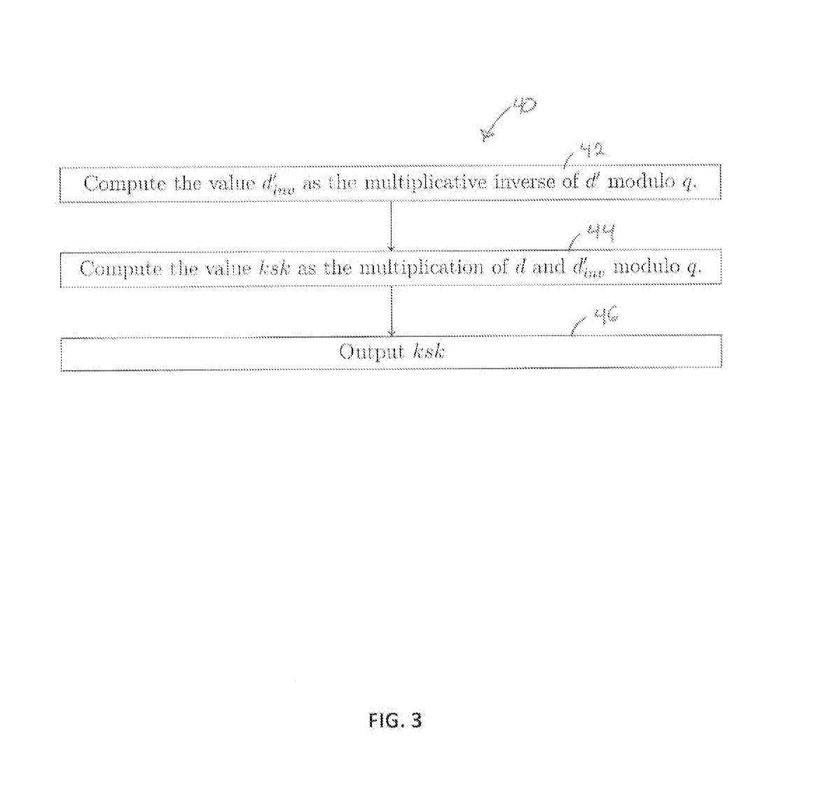

With these inputs, generating the Key-Switching Keys may include the following, as shown by process 40 of FIG. 3: computing the value d′ᵢₙᵥ as the multiplicative inverse (i.e., reciprocal) of d′ modulo q (block 42); and computing the value ksk (a key-switching key) as the multiplication of d and d′ᵢₙᵥ modulo q (block 44), e.g., d times (d′ᵢₙᵥ modulo q) or (d times d′ᵢₙᵥ) modulo q. Thus, some embodiments may output a key-switching key (block 46). Note that from a key-switching key ksk initially intended to be used to switch public keys from an original recipient to a delegated recipient, one may generate the opposite key-switching key ksk′, from the delegated recipient to the original recipient, by computing ksk′ as the multiplicative inverse of ksk modulo q.

With the key-switching key, some embodiments may perform key switching. This may include various inputs, including: 1) a bit string QE ∥ MaskedEncData∥ MacTag, representing a ciphertext (where ∥ is used to denote the concatenation of bit strings) that is compatible with ECIES; and 2) a key-switching key ksk, generated according to the aforementioned procedure, in some embodiments. In some cases, different computing devices may determine the ksk and apply the ksk to a ciphertext to delegate access to the ciphertext, and the computing device calculating the ksk may a) not have access to the ciphertext and b) provide the ksk to another computing device with access to the ciphertext.

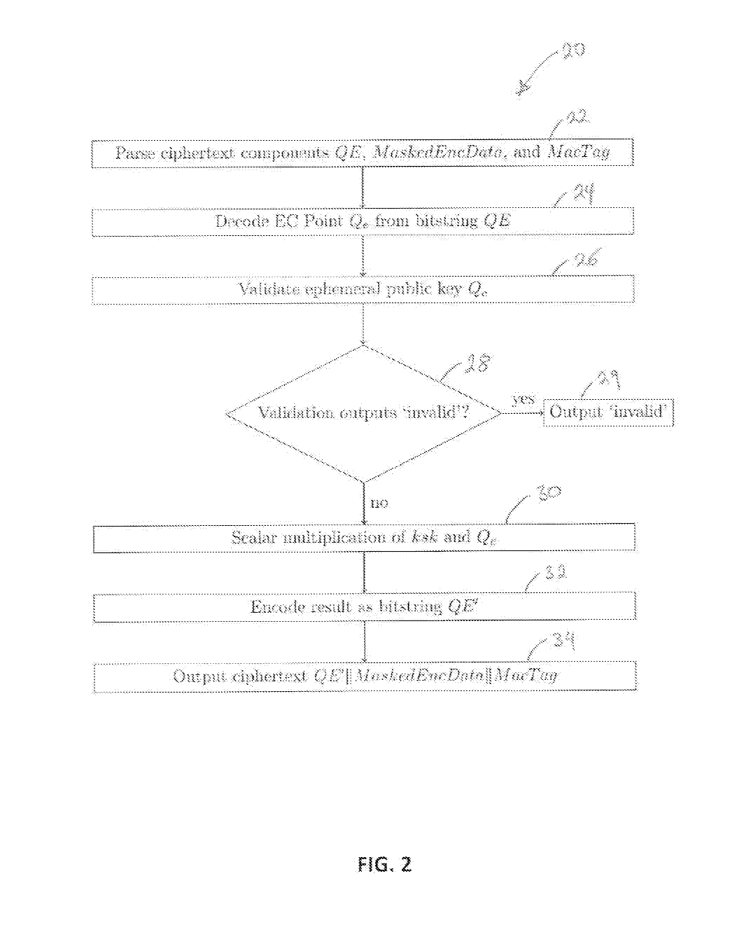

With these inputs, as shown by process 20 of FIG. 2, key switching may include the following: 1) parsing the bit strings QE, MaskedEncData, and MacTag from the ECIES-compatible ciphertext (block 22); 2) decoding the bit string QE as an elliptic curve point Qₑ using the procedure specified in Section 4.3.7 of the ANSI X9.63 standard (block 24); 3) validating the ephemeral public key Qₑ using the validation procedure specified in Section 5.2.2 of the ANSI X9.63 standard, in some embodiments (block 26); 4) determining whether the validation outputs “invalid” (block 28), in which case the operation may stop (block 29); 5) computing Q′ₑ as the EC scalar multiplication ksk·Qₑ (block 30); and 6) encoding Q′ₑ as a bit string QE′ using the procedure specified in Section 4.3.6 of the ANSI X9.63 standard, in some embodiments (block 32). Some embodiments may output the ciphertext characterized by the bit string QE′ ∥ MaskedEncData ∥ MacTag, or ‘invalid’ if some error occurred (block 34). In some cases, this process may be performed by a key switching server.

In order to prove the correctness of the key-switching procedure, the reader should consider why regular encryption and decryption procedures of ECIES work. During encryption of a ciphertext, a unique intermediate value KeyData is produced from the original public key Q and ephemeral private key d_{e,} and is used as the key material for both encryption and integrity assurance.

The decryption procedure of ECIES replicates this exact value, but through a different route, specifically from the knowledge of the ephemeral public key Qₑ and the recipient's private key d. The correctness of this (i.e., that decryption obtains the same KeyData value created in encryption) is ensured by the properties of the Diffie-Hellman key agreement. Denote as Diffie-Hellman(x,P) to the result of a standard Diffie-Hellman key agreement with private key x and public key P. Specifically, it can be shown that Diffie-Hellman(dₑ, Q)=Diffie-Hellman(d, Qₑ). Since public keys Q and Qₑ are valid EC public keys compatible with EC domain parameters D, it should be noted that Q=d·G and Qₑ=dₑ·G. Given that Diffie-Hellman(dₑ, Q)=dₑ·Q=dₑ·(d·G) and Diffie-Hellman(d, Qₑ)=d·Qₑ=d·(dₑ·G), then both obtain the same value d·dₑ·G, and hence, the same KeyData value.

It should be noted that the correctness of the key-switching procedure is an extension of this property. First note that when a recipient receives a ciphertext for decryption, it includes an encoding QE of the ephemeral public key Qₑ generated during encryption. The reader should consider the case now of a ciphertext switched from public key Q (with corresponding private key d) to public key Q′ (with corresponding private key d′). The corresponding key-switching key between public key Q and public key Q′ is ksk=d·(d′)⁻¹ modulo q, as follows from the procedure for generating key-switching keys described before.

Step 5 of the key switching process above (supra, paragraph 29) implies that the key-switching procedure modifies this ephemeral public key Qₑ contained in an ECIES-compatible ciphertext, so that the new ephemeral public key becomes Q′ₑ=d·(d′)⁻¹·dₑ·G. Following the same previous logic, it can be seen that the new recipient (with public key Q′ and private key d′) obtains the same KeyData value during decryption, since Diffie-Hellman (d′, Q′ₑ)=d′·Q′ₑ=d′·(d·(d′)⁻¹·dₑ·G) 32 d·dₑ·G, as before. Therefore, since the KeyData value is the same than the original produced during encryption, the decryption of a transformed ciphertext is ensured to be correct in some embodiments.

It should be noted also that the number of correct applications of this process to the same ciphertext is unbounded. In other words, the ciphertext resulting of the key-switching procedure can, in turn, be transformed again to a different public key, and this process may be repeated indefinitely.

Variants of ECIES have also been defined by other standard bodies, and the present techniques may be applied to those other variants and similar implementations. In particular, the variants proposed by ISO/IEC 18033-2 and IEEE P1363A are suitable (the contents of both of which are hereby incorporated by reference). However, both of these variants modify the encryption and decryption procedures by including the ephemeral public key as input to the key derivation function, which in principle breaks the possibility of switching keys in ciphertexts. The goal of this change is to get rid of the ciphertext malleability property in the ANSI X.93 version, which, although in principle benign, does not provide any advantage in a traditional setting (i.e., where ciphertexts are intended to be non-alterable) (which should not be read as a disclaimer). Nevertheless, for backwards compatibility with respect to ANSI X.93 version, both standards allow to ignore the ephemeral public key when evaluating the key derivation function, which enables switching keys of ciphertexts, as described herein.

ISO/IEC Standard 18033-2 defines a variant of ECIES that includes the mode called “SingleHashMode” that is backwards-compatible with ANSI X9.63 and, therefore, with embodiments of the present techniques.

IEEE Standard P1363A defines a variant of ECIES that includes the mode called “Non-DHAES ” that is backwards-compatible with ANSI X9.63 and, therefore, with embodiments of the present techniques.

By following the description of the ECIES variants proposed by these standards, and implementing that the aforementioned modes, some embodiments adapt the key switching procedure described herein to these variants. Consequently, the resulting system also falls within the scope of contemplated use cases.

In some embodiments, a first computing device with access to a first recipient's public key may encrypt a message with that pubic key to form a ciphertext. Embodiments may then send that ciphertext to a different computing device (e.g., over the Internet), which in some cases may be untrusted, and may not have access to the private key of the first recipient or the plaintext message. In some embodiments, the second, untrusted computing device may execute the above-described transformation on the ciphertext to transform the ciphertext from one decryptable with the first recipient's private key to a transformed ciphertext decryptable with a different, second recipient's private key (and in some cases, no longer decryptable with the first recipient's private key). In some embodiments, the message may then be sent (e.g., over the Internet) from the second computing device to a third computing device having access to the second recipient's private key, and the third computing device may decrypt the message with the second recipient's private key. In some cases, neither the message in plain text form, nor any of the private keys, may be accessible over the channels of communication noted or to the second computing device.

Other embodiments implement a different invention (which may be used in conjunction with, or in isolation from, the above techniques) that switches public keys in ciphertexts compatible with the ElGamal public-key encryption scheme, which can be described to work in a generic cyclic group F of primer order p, with generator P (see A. Menezes, P. Van Oorschot, and S. Vanstone. Handbook of Applied Cryptography. Section 8.4.2. CRC Press.) The following description uses the additive notation to describe operations in the group. Public and private keys in ElGamal are of the form x·P and x, respectively, for a value x sampled uniformly at random from {1, . . . , p-1}. Ciphertexts are tuples (γ, δ) of two elements of the group Γ.

Some embodiments define a key-switching key generation procedure that takes a private key x owned by the original recipient and a private key x′ owned by the delegated recipient; computes the value x′ᵢₙᵥ as the multiplicative inverse of x′ modulo p; and computes the value ksk (a key-switching key) as the multiplication of x and x′ᵢₙᵥ modulo p. Thus, some embodiments may output a key-switching key.

Some embodiments define a key-switching procedure that takes an ElGamal-compatible ciphertext (γ, δ) and a key-switching key ksk, and outputs the ciphertext (ksk·γ, δ).

### Use Cases

The following includes several example scenarios implementing the present techniques. The entities described in the following are considered merely examples (which is not to imply that any other feature is required in all implementations), and exemplify several possible instantiations (e.g., computers in a networked environment).

A Sender can be any computational entity (e.g., a process, a computer, a mobile device, an embedded system, a virtual machine, etc.) that generates data and sends it confidentially to a recipient, in the form of a ciphertext encrypted under the public key of the recipient.

A Recipient can be any computational entity that is entitled to read ciphertexts encrypted under his public key. In some cases, there are two types of recipients. The original recipient, which is the recipient of the data originally intended by the sender, and the delegated recipient, whom the original recipient entrusts to be able to decrypt ciphertexts initially intended to him. Therefore, there is a relation of delegation between the original recipient and the delegated one.

The Intermediary is a computational entity that controls the process of switching the public key of ciphertexts, from the public key of the original recipient to the public key of a delegated recipient, without being able to learn anything from the data (e.g., without being able to learn anything from at least an encrypted portion of the data). The Intermediary, in some embodiments, needs a key-switching key between the original and delegated recipients in order to be able to perform the key-switching process.

Senders and recipients may take any of a variety of forms. Examples are described in U.S. patent application Ser. No. 15/588,614, titled ENCRYPTION FOR DISTRIBUTED STORAGE AND PROCESSING, filed 06 May 2017, U.S. Provisional Patent Application 62/503,005, titled METHOD AND SYSTEM FOR SECURE DELEGATED ACCESS TO ENCRYPTED DATA IN BIG DATA COMPUTING CLUSTERS, filed 08 May 2017, U.S. Provisional Patent Application 62/502,938, titled HIGH-PERFORMANCE ACCESS MANAGEMENT AND DATA PROTECTION FOR DISTRIBUTED MESSAGING FRAMEWORKS AND LIBRARIES, filed 08 May 2017, and U.S. Pat. No. 9,519,798, titled ZERO-KNOWLEDGE DATABASES, filed 06 May 2016, the contents of each of which are hereby incorporated by reference. For instance, as described, access to stored data stored in a zero-knowledge database may be delegated, or the ability to access messages sent between processes in a distributed computing application may be delegated. Some embodiments may use proxy-reencryption for key rotation in distributed processing or messaging systems.

Some embodiments may include both a key encapsulation mechanism (KEM) a data encapsulation mechanism (DEM). The KEM may include generating a random value among the finite group of a public key system and deriving a symmetric key based on a cryptographic hash value calculated from the random value. Subsequent exchanges may then be encrypted with the symmetric key. Thus, some embodiments may implement a hybrid cryptosystem with features of both asymmetric encryption and symmetric encryption.

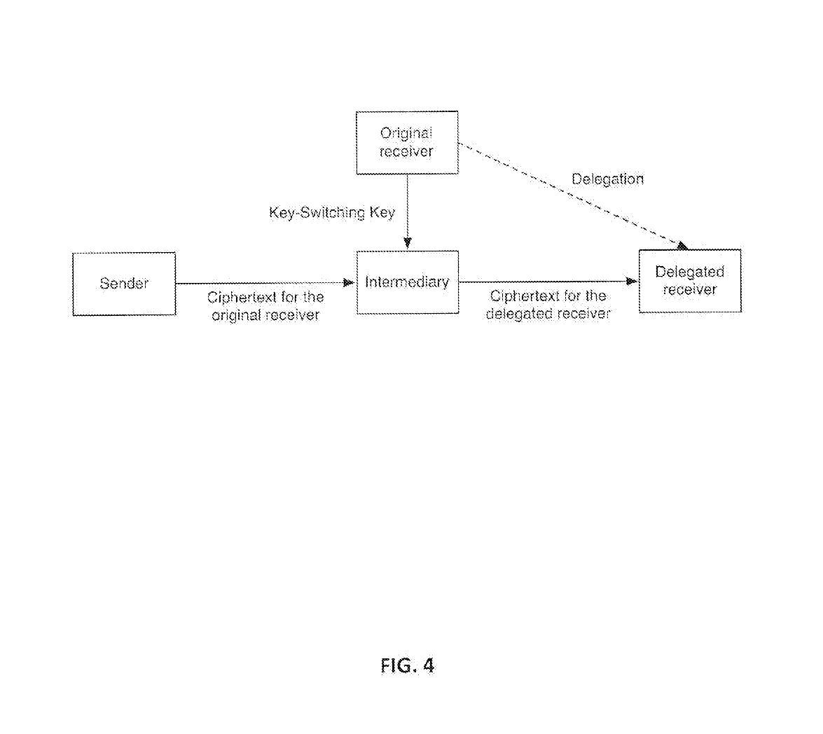

FIG. 4 is a block diagram depicting an example of a use case with one sender and one delegated recipient in accordance with various embodiments.

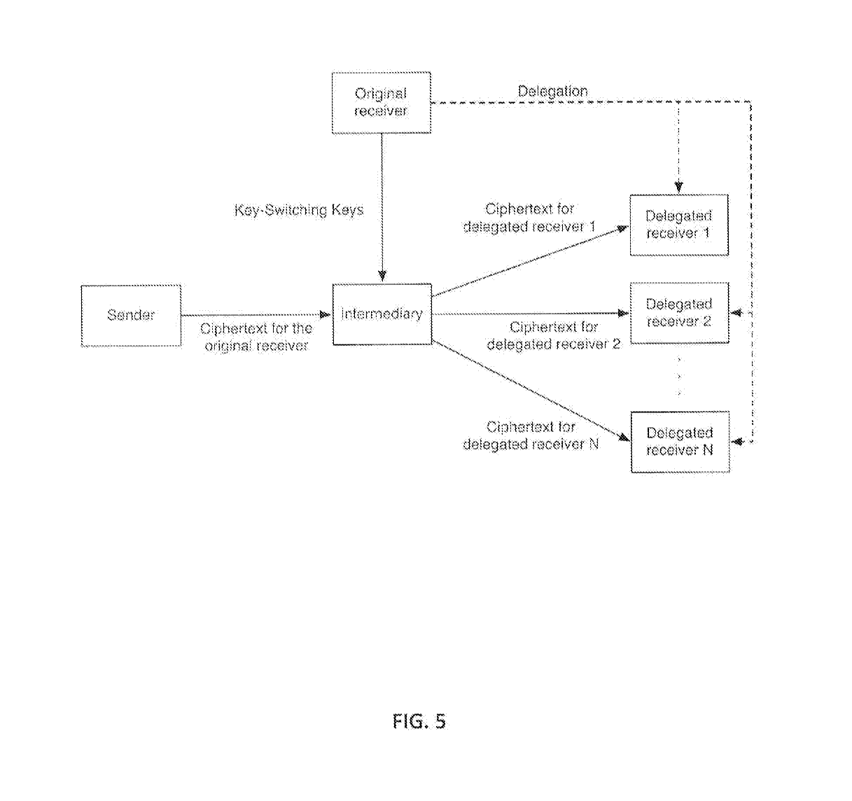

FIG. 5 is a block diagram depicting an example of a use case with one sender and multiple delegated recipients in accordance with various embodiments.

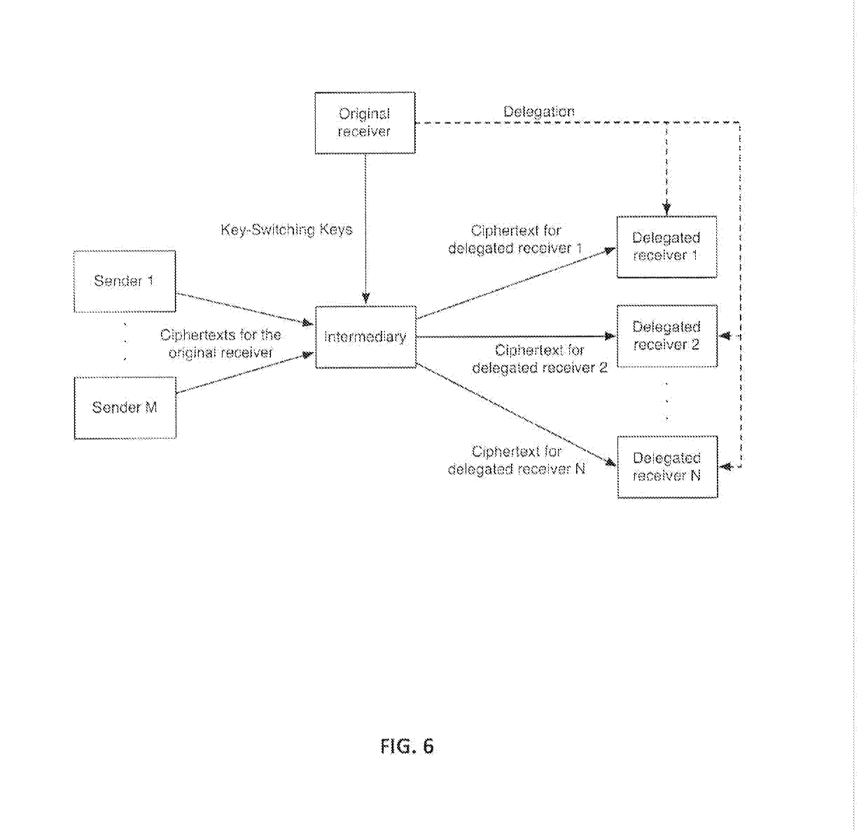

FIG. 6 is a block diagram depicting an example of a use case with multiple senders and multiple delegated in accordance with various embodiments.

FIG. 7 is a diagram that illustrates an exemplary computing system 1000 in accordance with embodiments of the present technique. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface may 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times, e.g., a copy may be created by writing program code to a first-in-first-out buffer in a network interface, where some of the instructions are pushed out of the buffer before other portions of the instructions are written to the buffer, with all of the instructions residing in memory on the buffer, just not all at the same time.

I/O interface 1050 may be configured to coordinate I/O traffic between processors 1010a-1010n system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present invention may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, third party content delivery networks may host some or all of the information conveyed over networks, in which case, to the extent information (e.g., content) is said to be supplied or otherwise provided, the information may provided by sending instructions to retrieve that information from a content delivery network.

The reader should appreciate that the present application describes several inventions. Rather than separating those inventions into multiple isolated patent applications, applicants have grouped these inventions into a single document because their related subject matter lends itself to economies in the application process. But the distinct advantages and aspects of such inventions should not be conflated. In some cases, embodiments address all of the deficiencies noted herein, but it should be understood that the inventions are independently useful, and some embodiments address only a subset of such problems or offer other, unmentioned benefits that will be apparent to those of skill in the art reviewing the present disclosure. Due to costs constraints, some inventions disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such inventions or all aspects of such inventions.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device.

The present techniques will be better understood with reference to the following enumerated embodiments:
1. A tangible, non-transitory, machine-readable medium storing instructions that when executed by one or more processors effectuate operations comprising: obtaining, with one or more processors, a first ciphertext, wherein: the first ciphertext is formed by encrypting a plaintext message with elliptic curve encryption; the elliptic curve encryption has a field size as a domain parameter; the field size is a prime number; the first ciphertext is encrypted based on a first public encryption key of a first recipient; the first public encryption key is part of a first encryption key pair; the first encryption key pair includes a first private encryption key corresponding to the first public encryption key; and the first ciphertext requires access to the first private encryption key to access the plaintext from the first ciphertext; obtaining, with one or more processors, the field size with which the first ciphertext was encrypted; obtaining, with one or more processors, the first private encryption key of the first encryption key pair; receiving, with one or more processors, a request to delegate access to the first ciphertext to a second recipient different from the first recipient, wherein: the second recipient corresponds to a second encryption key pair different from the first encryption key pair; and the second encryption key pair includes a second public encryption key and a second private encryption key; obtaining, with one or more processors, the second private encryption key; determining, with one or more processors, a key-switching key based on the field size, the first private encryption key, and the second private encryption key; in response to the request, delegating access by forming a second ciphertext from which the plaintext is accessible with the second private encryption key, wherein: forming the second ciphertext is performed without decrypting the first ciphertext or accessing the plaintext; forming the second ciphertext is performed without the second private encryption key; the second ciphertext requires access to the second private encryption key to access the plaintext from the second ciphertext; and the second ciphertext is formed based on the first ciphertext and the key-switching key; and storing, with one or more processors, the second ciphertext in memory.
2. The medium of embodiment 1, wherein: the first ciphertext and the second ciphertext are complaint with the Elliptic Curve Integrated Encryption Scheme (ECIES) Standard.
3. The medium of embodiment 1, wherein: the first ciphertext and the second ciphertext are complaint with the American National Standards Institute X9.63 Standard.
4. The medium of any one of embodiments 1-3, wherein determining the key-switching key is performed before receiving the request to delegate access.
5. The medium of any one of embodiments 1-4, wherein determining the key-switching key is performed before obtaining the first ciphertext.
6. The medium of any one of embodiments 1-5, wherein: determining the key-switching key is performed by first computing device; forming the second ciphertext is performed by a second computing device different from the first computing device; and the second computing device does not have access to the first private encryption key or the second private encryption key.
7. The medium of embodiment 6, wherein the operations comprise: associating the key-switching key with the second public key in a record accessible to the second computing device; and selecting the key-switching key based on the second public key by the second computing device.
8. The medium of any one of embodiments 1-7, wherein determining the key-switching key comprises: determining a private-key inverse based on a multiplicative inverse of the second private encryption key modulo the field size; and determining the key-switching key based on a product of the first private encryption key and the private-key inverse modulo the field size.
9. The medium of any one of embodiments 1-8, wherein determining the key-switching key comprises: steps for determining a key-switching key.
10. The medium of any one of embodiments 1-9, wherein forming the second ciphertext comprises: parsing a bit-string representation of the first public encryption key from a bit-string of the first ciphertext; parsing an encrypted form of the plaintext from the bit-string, the encrypted form of the plaintext being formed with an XOR operation; decoding the first public encryption key as an elliptic curve point based on the parsed bit-string representation of the first public encryption key; determining the second public encryption key based on the key-switching key and the first public encryption key; and encoding the second public encryption key as a bit-string representation of the second public encryption key.
11. The medium of embodiment 10, wherein: determining the second public encryption key comprises determining an elliptic curve scalar multiplication of the key-switching key and the first public encryption key.
12. The medium of embodiment 10, wherein forming the second ciphertext comprises: concatenating the bit-string representation of the second public encryption key and the encrypted form of the plaintext.
13. The medium of embodiment 10, wherein parsing the encrypted form of the plaintext further comprises parsing a message authentication code tag.
14. The medium of embodiment 10, wherein forming the second ciphertext comprises: validating the first public encryption key.
15. The medium of any one of embodiments 1-14, wherein the first public encryption key is an ephemeral public encryption key of a hybrid encryption protocol in which asymmetric encryption is used to exchange a symmetric encryption key that is used to encrypt and decrypt subsequent messages in an encrypted messaging session.
16. The medium of any one of embodiments 1-15, wherein forming the second ciphertext comprises steps for delegating access.
17. The medium of any one of embodiments 1-16, wherein: the first ciphertext and the second ciphertext are compliant with ISO/IEC Standard 18033-2.
18. The medium of any one of embodiments 1 and 4-17, wherein: the first ciphertext and the second ciphertext are compliant with IEEE Standard P1363A.
19. The medium of any one of embodiments 1 and 4-17, wherein: the first ciphertext and the second ciphertext are compliant with the ElGamal public-key encryption scheme.
19. A method comprising: the operations of any one of embodiments 1-19.
20. A system, comprising: one or more processors; and memory storing instructions that when executed by the processors cause the processors to effectuate operations comprising: the operations of any one of embodiments 1-19

What is claimed is:

1. A tangible, non-transitory, machine-readable medium storing instructions that when executed by one or more processors effectuate operations comprising:
obtaining, with one or more processors, a first ciphertext, wherein:
the first ciphertext is formed by encrypting a plaintext message with elliptic curve encryption;
the elliptic curve encryption has a field size as a domain parameter;
the field size is a prime number;
the first ciphertext is encrypted based on a first public encryption key of a first recipient;
the first public encryption key is part of a first encryption key pair;
the first encryption key pair includes a first private encryption key corresponding to the first public encryption key; and
the first ciphertext requires access to the first private encryption key to access the plaintext from the first ciphertext;
obtaining, with one or more processors, the field size with which the first ciphertext was encrypted;
obtaining, with one or more processors, the first private encryption key of the first encryption key pair;
receiving, with one or more processors, a request to delegate access to the first ciphertext to a second recipient different from the first recipient, wherein:
the second recipient corresponds to a second encryption key pair different from the first encryption key pair; and
the second encryption key pair includes a second public encryption key and a second private encryption key;
obtaining, with one or more processors, the second private encryption key;
determining, with one or more processors, a key-switching key based on the field size, the first private encryption key, and the second private encryption key;
in response to the request, delegating, with one or more processors, access by forming a second ciphertext from which the plaintext is accessible with the second private encryption key, wherein:
forming the second ciphertext is performed without decrypting the first ciphertext or accessing the plaintext;
forming the second ciphertext is performed without the second private encryption key;
the second ciphertext requires access to the second private encryption key to access the plaintext from the second ciphertext; and
the second ciphertext is formed based on the first ciphertext and the key-switching key; and
storing, with one or more processors, the second ciphertext in memory.

2. The medium of claim 1, wherein:
the first ciphertext and the second ciphertext are complaint with the Elliptic Curve Integrated Encryption Scheme (ECIES) Standard.

3. The medium of claim 1, wherein:
the first ciphertext and the second ciphertext are complaint with the American National Standards Institute X9.63 Standard.

4. The medium of claim 1, wherein determining the key-switching key is performed before receiving the request to delegate access.

5. The medium of claim 1, wherein determining the key-switching key is performed before obtaining the first ciphertext.

6. The medium of claim 1, wherein:
determining the key-switching key is performed by first computing device;
forming the second ciphertext is performed by a second computing device different from the first computing device; and
the second computing device does not have access to the first private encryption key or the second private encryption key.

7. The medium of claim 6, wherein the operations comprise:
associating the key-switching key with the second public key in a record accessible to the second computing device; and
selecting the key-switching key based on the second public key by the second computing device.

8. The medium of claim 1, wherein determining the key-switching key comprises:
determining a private-key inverse based on a multiplicative inverse of the second private encryption key modulo the field size; and
determining the key-switching key based on a product of the first private encryption key and the private-key inverse modulo the field size.

9. The medium of claim 1, wherein determining the key-switching key comprises:
steps for determining a key-switching key.

10. The medium of claim 1, wherein forming the second ciphertext comprises:
parsing a bit-string representation of the first public encryption key from a bit-string of the first ciphertext;
parsing an encrypted form of the plaintext from the bit-string, the encrypted form of the plaintext being formed with an XOR operation;
decoding the first public encryption key as an elliptic curve point based on the parsed bit-string representation of the first public encryption key;
determining the second public encryption key based on the key-switching key and the first public encryption key; and
encoding the second public encryption key as a bit-string representation of the second public encryption key.

11. The medium of claim 10, wherein:
determining the second public encryption key comprises determining an elliptic curve scalar multiplication of the key-switching key and the first public encryption key.

12. The medium of claim 10, wherein forming the second ciphertext comprises:
concatenating the bit-string representation of the second public encryption key and the encrypted form of the plaintext.

13. The medium of claim 10, wherein parsing the encrypted form of the plaintext further comprises parsing a message authentication code tag.

14. The medium of claim 10, wherein forming the second ciphertext comprises:
validating the first public encryption key.

15. The medium of claim 1, wherein the first public encryption key is an ephemeral public encryption key of a hybrid encryption protocol in which asymmetric encryption is used to exchange a symmetric encryption key that is used to encrypt and decrypt subsequent messages in an encrypted messaging session.

16. The medium of claim 1, wherein forming the second ciphertext comprises steps for delegating access.

17. The medium of claim 1, wherein:
the first ciphertext and the second ciphertext are compliant with ISO/IEC Standard 18033-2.

18. The medium of claim 1, wherein:
the first ciphertext and the second ciphertext are compliant with IEEE Standard P1363A.

19. The medium of claim 1, wherein:
the first ciphertext and the second ciphertext are compliant with the ElGamal public-key encryption scheme.

20. A method, comprising:
obtaining, with one or more processors, a first ciphertext, wherein:
the first ciphertext is formed by encrypting a plaintext message with elliptic curve encryption;
the elliptic curve encryption has a field size as a domain parameter;
the field size is a prime number;
the first ciphertext is encrypted based on a first public encryption key of a first recipient;
the first public encryption key is part of a first encryption key pair;
the first encryption key pair includes a first private encryption key corresponding to the first public encryption key; and
the first ciphertext requires access to the first private encryption key to access the plaintext from the first ciphertext;
obtaining, with one or more processors, the field size with which the first ciphertext was encrypted;
obtaining, with one or more processors, the first private encryption key of the first encryption key pair;
receiving, with one or more processors, a request to delegate access to the first ciphertext to a second recipient different from the first recipient, wherein:
the second recipient corresponds to a second encryption key pair different from the first encryption key pair; and
the second encryption key pair includes a second public encryption key and a second private encryption key;
obtaining, with one or more processors, the second private encryption key;
determining, with one or more processors, a key-switching key based on the field size, the first private encryption key, and the second private encryption key;
in response to the request, delegating, with one or more processors, access by forming a second ciphertext from which the plaintext is accessible with the second private encryption key, wherein:
forming the second ciphertext is performed without decrypting the first ciphertext or accessing the plaintext;
forming the second ciphertext is performed without the second private encryption key;
the second ciphertext requires access to the second private encryption key to access the plaintext from the second ciphertext; and
the second ciphertext is formed based on the first ciphertext and the key-switching key; and
storing, with one or more processors, the second ciphertext in memory.
